(19) United States
(12) Patent Application Publication
(10) Pub. No.: US 2021/0374667 A1
(43) Pub. Date: Dec. 2, 2021

(54) METHOD AND SYSTEM FOR GENERATING BILL OF MATERIALS FOR A PRODUCT

(71) Applicant: HCL Technologies Limited, New Delhi (IN)

(72) Inventors: Yuvaraj D. Patil, Bengaluru (IN); Mohan Sriram, Bengaluru (IN)

(73) Assignee: HCL Technologies Limited, New Delhi (IN)

(21) Appl. No.: 17/334,712

(22) Filed: May 29, 2021

(30) Foreign Application Priority Data
Jun. 2, 2020 (IN) 202011023185

(51) Int. Cl. G06Q 10/08; G06Q 30/06; G06Q 30/02; G06F 3/0482

(52) U.S. Cl. CPC G06Q 10/0875; G06F 3/0482; G06Q 30/0283; G06Q 30/0621

(57) ABSTRACT

The invention relates to method and system for generating a Bill of Materials (BOM) for a product. In some embodiments, the method includes acquiring information associated with a component of the product using communicatively connected information recording instruments. The information may include measurement parameters recorded using communicatively connected measuring instruments. The method further includes automatically populating a set of data fields from among a plurality of data fields in a graphic user interface (GUI) based on the acquired information and a shape of the component, receiving a validation command from the user via the GUI, and storing the plurality of data fields as one of a plurality of records in a BOM database for the product upon receiving the validation command. The shape of the component may be selected by a user from a list of pre-defined shapes or may be identified based on an image of the component.

### FIELD OF INVENTION

Generally, the invention relates to Bill of Materials (BOM). More specifically, the invention relates to method and system for automatically generating BOM for a product.

### BACKGROUND OF INVENTION

Bill of Material (BOM) for any product is a comprehensive list of components of that product along with all their details. Typically, BOM generation is a manual, labour intensive, and time-consuming process using spreadsheet templates. Depending upon size of the product, the number of components may range from few hundreds to few thousands. Thus, the manual process to generate BOM may consume several days to few months, when the product has large number of components. For example, a product may include thousand components or parts. In such case, analysing each of the thousand components or parts to generate BOM, may be extremely difficult for persons involved in generating BOM. Also, the manual process is mundane and prone to human errors that may impact the accuracy and quality of BOM and subsequent analysis. In short, the current BOM generation techniques are highly unproductive, inefficient, and prone to human errors, thereby impacting subsequent workflow and go-to-market.

### SUMMARY OF INVENTION

In one embodiment, a method of generating a Bill of Materials (BOM) for a product is disclosed. The method may include acquiring information associated with a component of the product using a plurality of communicatively connected information recording instruments. The information may include a set of measurement parameters recorded using a set of communicatively connected measuring instruments. The method may further include automatically populating a set of data fields in a graphic user interface (GUI) based on the acquired information and a shape of the component. It should be noted that the shape of the component may be selected by a user from a list of pre-defined shapes or may be identified based on an image of the component, and the set of data fields may be among a plurality of data fields in the GUI. The method may further include receiving a validation command from the user via the GUI. The method may further include storing the plurality of data fields as one of a plurality of records in a BOM database for the product upon receiving the validation command. It should be noted that each of the plurality of records in the BOM database may correspond to each of a plurality of components in the product.

In another embodiment, a system for generating a BOM for a product is disclosed. The system may include a processor and a memory communicatively coupled to the processor. The memory may store processor-executable instructions, which, on execution, may causes the processor to acquire information associated with a component of the product using a plurality of communicatively connected information recording instruments. The information may include a set of measurement parameters recorded using a set of communicatively connected measuring instruments. The processor-executable instructions, on execution, may further cause the processor to automatically populate a set of data fields in a GUI based on the acquired information and a shape of the component. It should be noted that the shape of the component may be selected by a user from a list of pre-defined shapes or may be identified based on an image of the component, and the set of data fields may be among a plurality of data fields in the GUI. The processor-executable instructions, on execution, may further cause the processor to receive a validation command from the user via the GUI. The processor-executable instructions, on execution, may further cause the processor to store the plurality of data fields as one of a plurality of records in a BOM database for the product upon receiving the validation command. It should be noted that each of the plurality of records in the BOM database may correspond to each of a plurality of components in the product.

### BRIEF DESCRIPTION OF THE DRAWINGS

The present application can be best understood by reference to the following description taken in conjunction with the accompanying drawing figures, in which like parts may be referred to by like numerals

FIG. 1 is a block diagram of an exemplary system for generating Bill of Material (BOM) for a product, in accordance with some embodiments of the present disclosure.

FIG. 2 is a functional block diagram of an exemplary BOM generating device, in accordance with some embodiments of the present disclosure.

FIG. 3 is a flow diagram of an exemplary process for generating BOM for a product, in accordance with some embodiments of the present disclosure.

FIG. 4 illustrates an exemplary GUI rendered by the BOM generating device, in accordance with some embodiments of the present disclosure.

FIGS. 5A-5D are flow diagrams of a detailed exemplary process of generating BOM for a product, in accordance with some embodiments of the present disclosure.

FIG. 6 is a flow diagram of an exemplary process for generating a measure report, in accordance with some embodiments of the present invention.

FIG. 7 is a flow diagram of an exemplary process for generating a cost report, in accordance with some embodiments of the present invention.

FIG. 8 is a flow diagram of an exemplary process for generating a FAST report, in accordance with some embodiments of the present invention.

FIG. 9 is a flow diagram of an exemplary process for generating a FAST diagram using functional values' information, in accordance with some embodiments of the present invention.

### DETAILED DESCRIPTION OF THE DRAWINGS

The following description is presented to enable a person of ordinary skill in the art to make and use the invention and is provided in the context of particular applications and their requirements. Various modifications to the embodiments will be readily apparent to those skilled in the art, and the generic principles defined herein may be applied to other embodiments and applications without departing from the spirit and scope of the invention. Moreover, in the following description, numerous details are set forth for the purpose of explanation. However, one of ordinary skill in the art will realize that the invention might be practiced without the use of these specific details. In other instances, well-known structures and devices are shown in block diagram form in order not to obscure the description of the invention with unnecessary detail. Thus, the present invention is not intended to be limited to the embodiments shown, but is to be accorded the widest scope consistent with the principles and features disclosed herein.

While the invention is described in terms of particular examples and illustrative figures, those of ordinary skill in the art will recognize that the invention is not limited to the examples or figures described. Those skilled in the art will recognize that the operations of the various embodiments may be implemented using hardware, software, firmware, or combinations thereof, as appropriate. For example, some processes can be carried out using processors or other digital circuitry under the control of software, firmware, or hard-wired logic. (The term “logic” herein refers to fixed hardware, programmable logic and/or an appropriate combination thereof, as would be recognized by one skilled in the art to carry out the recited functions.) Software and firmware can be stored on computer-readable storage media. Some other processes can be implemented using analog circuitry, as is well known to one of ordinary skill in the art. Additionally, memory or other storage, as well as communication components, may be employed in embodiments of the invention.

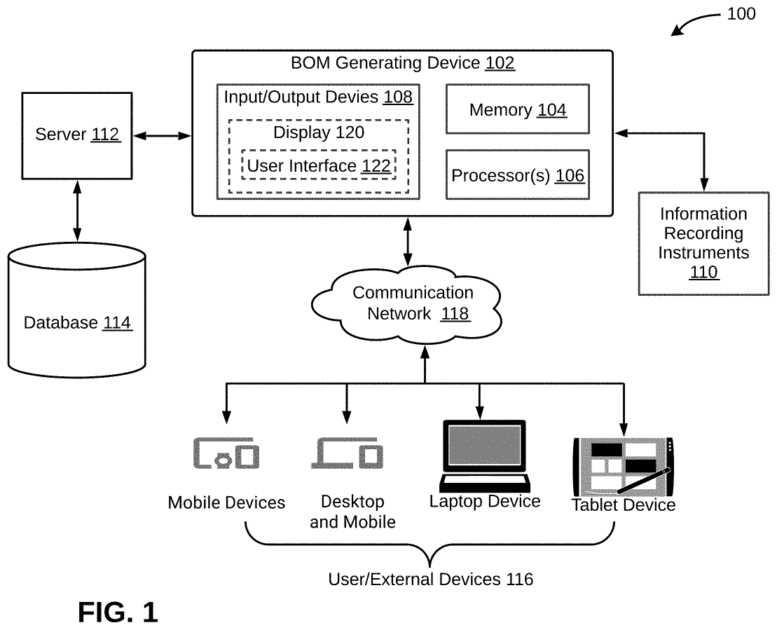

Referring now to FIG. 1, a block diagram of a system 100 for generating Bill of Material (BOM) for a product is illustrated, in accordance with some embodiments of the present disclosure. In an embodiment, the system 100 may be used to resolve aforementioned problems by automatically generating BOM for the product with high accuracy, using a BOM generating device 102. The BOM generating device 102 generates a measure report, a BOM report, a cost report, and/or a FAST report for the product. In particular, the BOM generating device 102 may acquire information corresponding to a component of the product via communicatively connected information recording instruments 110. The BOM generating device 102 then automatically populate a set of data fields in a Graphical User Interface (GUI) 122 based on the fetched information of the component. The set of populated data fields in the GUI 122 may be then stored in a BOM database, upon validation by a user, as one of a number of records corresponding to a number of components of the product.

Examples of the BOM generating device 102 may include, but are not limited to, a server, a desktop, a laptop, a notebook, a tablet, a smartphone, a mobile phone, an application server, or the like. The BOM generating device 102 may include a memory 104, a processor 106, and an input/output (I/O) device 108. The I/O device 108 may further include a display 120 which may render a user interface 122 (e.g., GUI). A user or an administrator may interact with the BOM generating device 102 and vice versa through the user interface 122. By way of an example, the user interface 122 may be used to provide results of analysis performed by the BOM generating device 102, to the user. By way of another example, the user interface 110 may be used by the user/administrator to provide inputs to the BOM generating device 102.

As will be described in greater detail herein below, in order to generate BOM, the BOM generating device 102 may acquire information (e.g., measurement parameters, image, identification number, etc.) corresponding to the component of the product via one or more communicatively connected information recording instruments 110. Additionally, in some embodiments, the BOM generating device 102 may extract information (e.g., image, component description, etc.) corresponding to the component of the product from a server 112, which is further communicatively coupled to a database 114.

The memory 104 and the processor 106 of the BOM generating device 102 may perform various functions including acquiring information, processing information, populating data fields, receiving commands, and storing the data fields. The memory 104 may store instructions that, when executed by the processors 106, cause the processors 106 to generate BOM based on information corresponding to the component of the product, in accordance with some embodiments of the present invention. The memory 104 may also store various data (e.g. image of the component, shape of the component, measurement parameters, material details, the cost report, the measure report, the BOM report, the FAST report, etc.) that may be captured, processed, generated, and/or required by the BOM generating device 102. The memory 104 may be a non-volatile memory (e.g., flash memory, Read Only Memory (ROM), Programmable ROM (PROM), Erasable PROM (EPROM), Electrically EPROM (EEPROM) memory, etc.) or a volatile memory (e.g., Dynamic Random Access Memory (DRAM), Static Random-Access memory (SRAM), etc.).

In some embodiments, the BOM generating device 102 may interact with the user or the administrator via external devices 116 over a communication network. In such embodiments, the BOM generating device 102 may render the user interface 110 over the external devices 116. The user/administrator may provide inputs to the BOM generating device 102 via the user interface 110. Additionally, in such embodiments, the BOM generating device 102 may acquire information (e.g., measurement parameters, image, identification number, etc.) corresponding to the component of the product via one or more information recording instruments 110 communicatively connected to the external devices 116. Thus, for example, in such embodiments, the BOM generating device 102 may ingest information corresponding to the product provided by the user/administrator or acquired by the information recording instruments 110 via the external devices 116. Further, for example, in such embodiments, the BOM generating device 102 may render results (e.g., the measure report, the BOM report, the cost report, the FAST report, etc.) to the user/administrator via the external devices 116. The one or more external devices 116 may include, but may not be limited to, a desktop, a laptop, a notebook, a netbook, a tablet, a smartphone, a remote server, a mobile phone, or another computing system/device. The communication network 118 may be any wired or wireless communication network and the examples may include, but may be not limited to, the Internet, Wireless Local Area Network (WLAN), Wi-Fi, Long Term Evolution (LTE), Worldwide Interoperability for Microwave Access (WiMAX), and General Packet Radio Service (GPRS).

Further, the BOM generating device 102 may interact with the external devices 116 and/or the server 112 for sending/receiving various data. For example, in some embodiments, the BOM generating device 102 may receive information about the component (e.g., image of the component) from the server 112 or send the generated reports to the server 112. The server 112 is further communicatively coupled to a database 114, which may store the images sought by the BOM generating device 102 or reports generated by the BOM generating device 102. Similarly, for example, in some embodiments, the BOM generating device 102 may interact with one or more external devices 116 for sending and receiving various data.

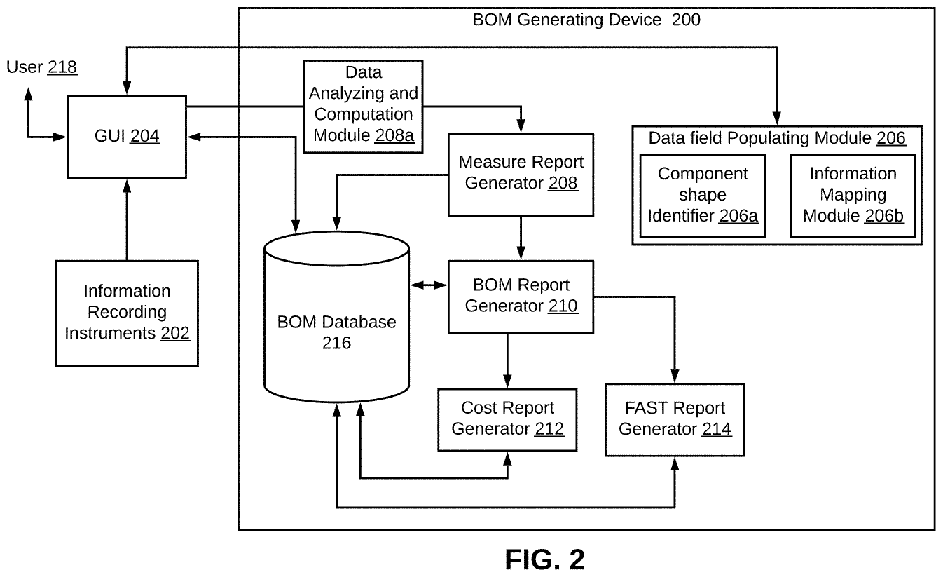

Referring now to FIG. 2, a block diagram of an exemplary BOM generating device 200 (analogous to the BOM generating device 102 implemented by the system 100 of FIG. 1) is illustrated, in accordance with some embodiments of the present disclosure. The BOM generating device 200 may acquire information about a product or a component of the product from various connected information recording instruments 202 through a Graphical User Interface (GUI) 204. In particular, the BOM generating device 200 may organize various functions under various modules including, but not limited to, a data field populating module 206, a measure report generator 208, a BOM report generator 210, a cost report generator 212, a FAST report generator 214, and a BOM database 216. The data field populating module 206 may further include a component shape identifier 206a and an information mapping module 206b. In some embodiments, information recorded by the information recording instruments 202 may be used as input to generate BOM for the product. Further, various reports may be provided as output to a user 218 via the GUI 204, based on a user requirement.

The information recording instruments 202 may record information associated with the component of the product. In some embodiments, information may be a set of measurement parameters recorded by various measuring instruments. It should be noted that the set of measuring parameters such as a height of the component, a length of the component, a width of the component, a weight of the component, a diameter of the component, and a thickness, may be recorded by the measuring instruments. Further, the measuring instruments may include, but not limited to, a digital tape, a digital Vernier scale, a micrometre, a digital height gauge, and a digital weighing scale.

Additionally, in some other embodiments, information may be an image of the component captured by a communicatively connected imaging device such as a web camera. Also, information may include an identification number or a bar code of the component. In order to capture the identification number of the component the imaging device or a communicatively connected bar code scanning device may be used.

The GUI 204 may be communicatively connected to the information recording instruments 202. The GUI 204 may be configured to receive information recorded by the information recording devices 202. It should be noted that a wireless connection like radio frequency technology, wireless internet or blue tooth connectivity may be established between the information recording instruments 202 and the GUI 204 for transferring and receiving information. The BOM generating device 200 may be initialized after receiving the information from the information recording instruments 202. In some embodiments a computing device such as a laptop, a computer, a mobile, a tablet or the like may be used to receive the information from the information recording instruments 202. The GUI 204 may include a plurality of data fields, for example, measuring data fields and material details. In such plurality of data fields, some of the plurality of data fields may be populated by the user 218. And, other may be populated by the data field populating module 206, automatically, as a set of data fields. Further, the GUI 204 may be operatively connected to the BOM generating device 200 to generate BOM for the product.

The data field populating module 206 of the BOM generating device 200 may be configured to receive recorded information. Further, the set of data fields from the plurality of data fields in the GUI 204 may be populated automatically by the data field populating module 206. In some embodiments, the set of data fields may be populated automatically, based on information and shape of the component. The component shape identifier 206a of the data field populating module 206 may identify shape of the component. Whether it is a square shape, a rectangular shape, a circular shape or other. To identify shape of the component, the component shape identifier 206a may analyze image of the component and based on that, shape of the component may be selected. In some embodiments, shape of the component may be selected by the user 218 from a list of pre-defined shapes. And, for the selected shape, associated data fields may be populated by the data field populating module 206.

For identifying shape of the component an image processing algorithm may be used by the component shape identifier 206a. In some embodiments, the component shape identifier 206a may be trained and tested with a plurality of training and test images for greater accuracy. On the other hand, information mapping module 206b may map each of the set of measurement parameters with each of the set of data fields based on the identified shape of the component. In some other embodiments, the information mapping module 206b may perform mapping based on the shape selected by the user 218.

Further, the BOM generating device 200 may receive additional information associated with the component from the user 218 via the GUI 204. In such embodiments, the additional information may correspond to remaining of the plurality of data fields in the GUI 204.

The plurality of data fields may be acquired by the measure report generator 208 in order to generate a measure report. The measure report generator 208 may evaluate the plurality of data fields populated in the GUI 204 and accordingly generates the measure report as one of the plurality of records in the BOM database. For generating the measure report, a data computation and analyzation may be performed on the plurality of data fields, by the data analyzing and computation module 208a. The data analyzing and computation module 208a may be connected between the GUI 204 and the measure report generator 208. The measure report may be further stored in the connected BOM database 216 for subsequent processing.

The BOM report generator 210 is communicatively connected to the BOM database 216 as well as the measure report generator 208. In some embodiments, the BOM report generator 210 may directly receive the generated measure report from the measure report generator 208. In some other embodiments, the BOM report generator 210 may access the plurality of records in the BOM database 216 to generate a BOM report based on the plurality of records in the BOM database 216. Each of the plurality of records may correspond to at least one component in the product. Thereafter, the generated BOM report may be stored in the BOM database 216 or transferred to the cost report generator 212 or the FAST report generator 214.

The cost report generator 212 may access the generated BOM report stored in the BOM database 216 or directly interact with the connected BOM report generator 210. Afterwards, a cost estimation may be performed on the BOM report by the cost report generator 212. Based on the cost estimation, the cost report may be generated and stored in the BOM database 216 for further processing. On the other hand, the FAST report generator 214 may perform a functional value analysis based on the BOM report. And, based on the functional value analysis, a FAST report may be generated by the FAST report generator 214. The FAST report generator 214 may be further communicatively connected to the BOM database 216 to store the generated FAST report that may be accessed by the user 218 upon requirement.

The BOM database 218 may be communicatively interconnected to the GUI 204, the measure report generator 208, the BOM report generator 210, the cost report generator 212, and the FAST report generator 214. The BOM database 218 may be configured to store intermediate and final results generated by the various modules 204-214. In some embodiments, the BOM database 218 may store the measure report as on of the plurality of records, the cost report, the BOM report, and the FAST report. Upon requirement, the user 218 may access the BOM database via the GUI 206.

It should be noted that the BOM generating device 102 may be implemented in programmable hardware devices such as programmable gate arrays, programmable array logic, programmable logic devices, or the like. Alternatively, the BOM generating device 102 may be implemented in software for execution by various types of processors. An identified engine/module of executable code may, for instance, include one or more physical or logical blocks of computer instructions which may, for instance, be organized as a component, module, procedure, function, or other construct. Nevertheless, the executables of an identified engine/module need not be physically located together but may include disparate instructions stored in different locations which, when joined logically together, comprise the identified engine/module and achieve the stated purpose of the identified engine/module. Indeed, an engine or a module of executable code may be a single instruction, or many instructions, and may even be distributed over several different code segments, among different applications, and across several memory devices.

As will be appreciated by one skilled in the art, a variety of processes may be employed for generating BOM for a product. For example, the exemplary system 100 and associated BOM generating device 102 may generate BOM for the product, by the process discussed herein. In particular, as will be appreciated by those of ordinary skill in the art, control logic and/or automated routines for performing the techniques and steps described herein may be implemented by the system 100 and the associated BOM generating device 102 either by hardware, software, or combinations of hardware and software. For example, suitable code may be accessed and executed by the one or more processors on the system 100 to perform some or all of the techniques described herein. Similarly, application specific integrated circuits (ASICs) configured to perform some or all the processes described herein may be included in the one or more processors on the system 100.

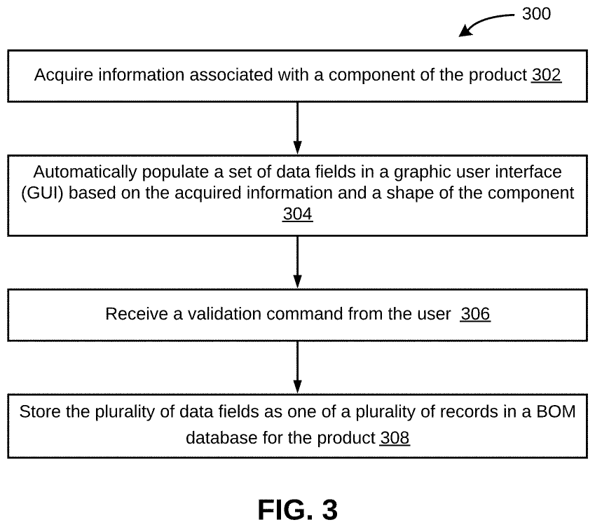

Referring now to FIG. 3, an exemplary process 300 for generating BOM for a product is depicted via a flowchart, in accordance with some embodiments of the present disclosure. Each of the steps of process 300 may be performed by the BOM generating device 102.

At step 302, information associated with a component of the product may be acquired. To acquire information, a plurality of communicatively connected information recording instruments 202 may be used by the BOM generating device 102 or 200. It should be noted that the information includes a set of measurement parameters that may be recorded using a set of communicatively connected measuring instruments. The set of measurement parameters may include at least one of a height of the component, a length of the component, a width of the component, a weight of the component, a diameter of the component, and a thickness of the component.

Further, the set of communicatively connected measuring instruments may include a digital tape, a digital Vernier scale, a digital micrometre, a digital height gauge, and a digital weighing scale. In some embodiments, the information may further include the image of the component captured using a communicatively connected imaging device. The communicatively connected imaging device may be a web camera. Further, in some embodiments, the information may include an identification number of the component. The identification number may be captured using one of the communicatively connected imaging device and the communicatively connected bar code scanning device.

At step 304, a set of data fields may be automatically populated in a GUI (analogues to the GUI 204 in FIG. 2). It should be noted that acquired information and a shape of the component may be considered for automatically populating the set of data fields. In some embodiments, the shape of the component may be selected by a user from a list of pre-defined shapes. Additionally, in some embodiments the shape of the component may be identified based on an image of the component. An image processing algorithm may be used for identification of the shape of the component from the image of the component. The shape may be at least one of a rectangular shape, a circular shape, and a sheet shape. It should be noted that the set of data fields may be among a plurality of data fields in the GUI. In some embodiments, the set of data fields is automatically populating by mapping each of the set of measurement parameters with each of the set of data fields based on the shape of the component. Further, in some embodiments, the process 300 may include the step of receiving additional information associated with the component from the user via the GUI. In such embodiments, the additional information may correspond to remaining of the plurality of data fields in the GUI.

At step 306, a validation command may be received from the user via the GUI. For example, in some embodiments, the user may use a save key to transmit the validation command. At step 308, upon receiving the validation command, the plurality of data fields may be stored as one of a plurality of records in a BOM database for the product. In some embodiments, each of the plurality of records in the BOM database may correspond to each of a plurality of components in the product. In some embodiments, the process 300 may include the step of generating at least one of a measure report, a BOM report, a cost report, and a FAST report.

The measure report may be generated based on an evaluation of the plurality of data fields prior to storing the plurality of data fields as one of the plurality of records in the BOM database. Additionally, the BOM report may be generated based on the plurality of records in the BOM database. For generating the cost report, a cost estimation may be performed based on the BOM report. Further, for generating the FAST report, a functional value analysis may be performed based on at least one of the BOM report and the cost report. The functional analysis may include a set of pre-defined functions and sub-functions customized for the product and mapped to a plurality of components of the product.

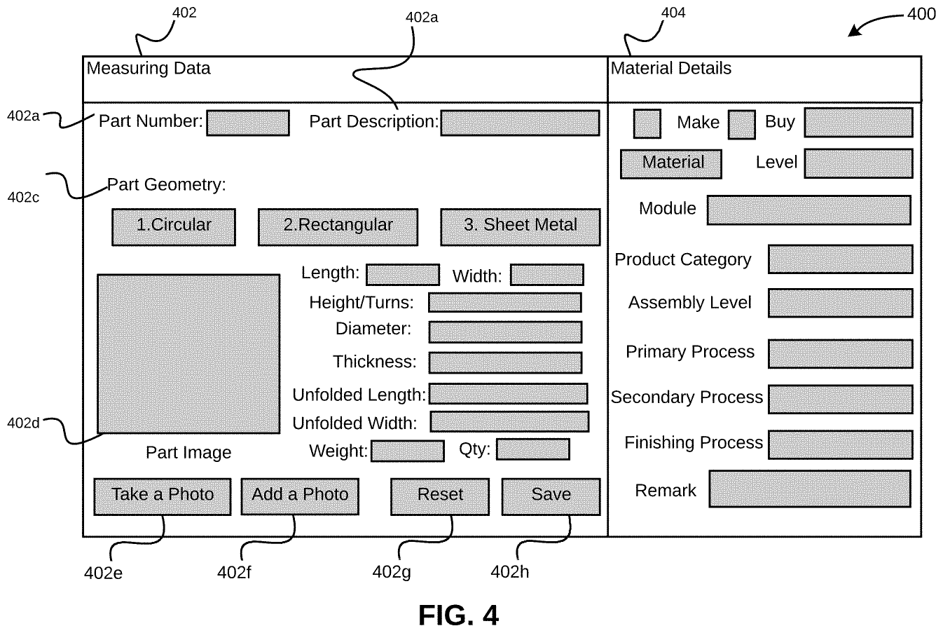

Referring now to FIG. 4, an exemplary GUI 400 rendered by the BOM generating device 102 is illustrated, in accordance with some embodiments of the present disclosure. The plurality of data fields may be divided into two sections. A first section may include measuring data 402 and a second section may include material details 404. The measuring data 402 may include various sub sections, but not limited to, a part number 402a, a part description 402b, a part geometry 402c, and a part image 402d. A part may correspond to the component of the product. The part geometry 402c may correspond geometry of a component, for example, a rectangular shape, a circular shape, and a sheet shape.

In some embodiments, the part geometry 402c may be automatically selected by the data field populating module 206 upon identification of shape of the component, when image of the component is analysed. Also, a user may select the part geometry 402c. Based on the selected part geometry 402c, various empty fields of measurement parameters associated with the part geometry 402c may be displayed on the GUI 204.

For example, the empty fields for measurement parameters may include a height of the component, a length of the component, a width of the component, a weight of the component, unfolded length, unfolded width, a diameter of the component, and a thickness of the component. These fields of measurement parameters may be different for different shapes. Like, in case of circular shape the measurement parameter ‘diameter of the component’ may be displayed, however that may not appear in case of rectangular or square shape. These fields of measurement parameters may be populated based on information captured by the information recording instruments 202. Further, the part image 402d may be populated either by selecting a ‘Take a photo’ option 402e or by selecting ‘Add a photo’ option 402f.

When the ‘Take a photo’ option 402e is selected by the user 218, an associated camera module may get a command to capture a picture. And, by selecting the ‘Add a photo’ option 402f, the user 218 may be able to select one of the existing pictures stored in a database. A reset key may enable the user to reset the plurality of data fields and the save key may be used to store the plurality of data fields as one of the plurality of records. On the other side, the second section of material details may include empty fields for ‘Material Type’, ‘Make’, ‘Buy’, ‘Level’, ‘Module’, ‘Product Category’, ‘Assembly level’, ‘Primary Process’, ‘Secondary Process’, ‘Finishing Process’, and ‘Remark’.

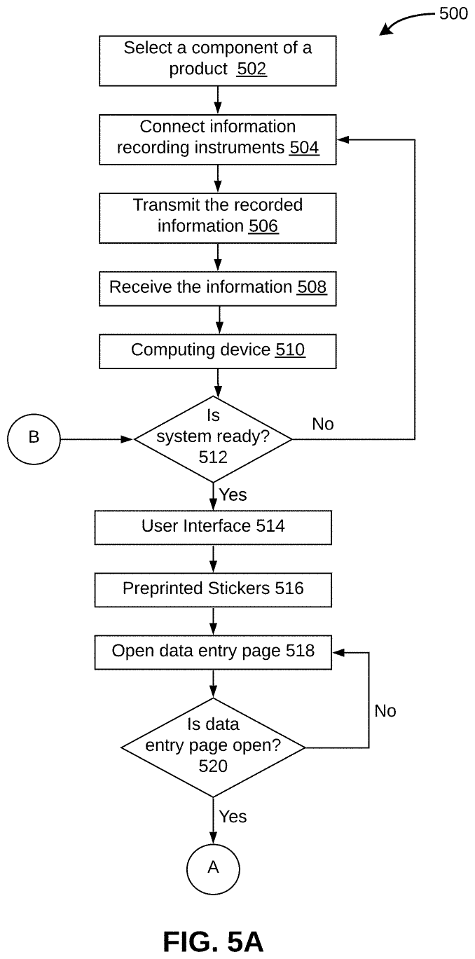

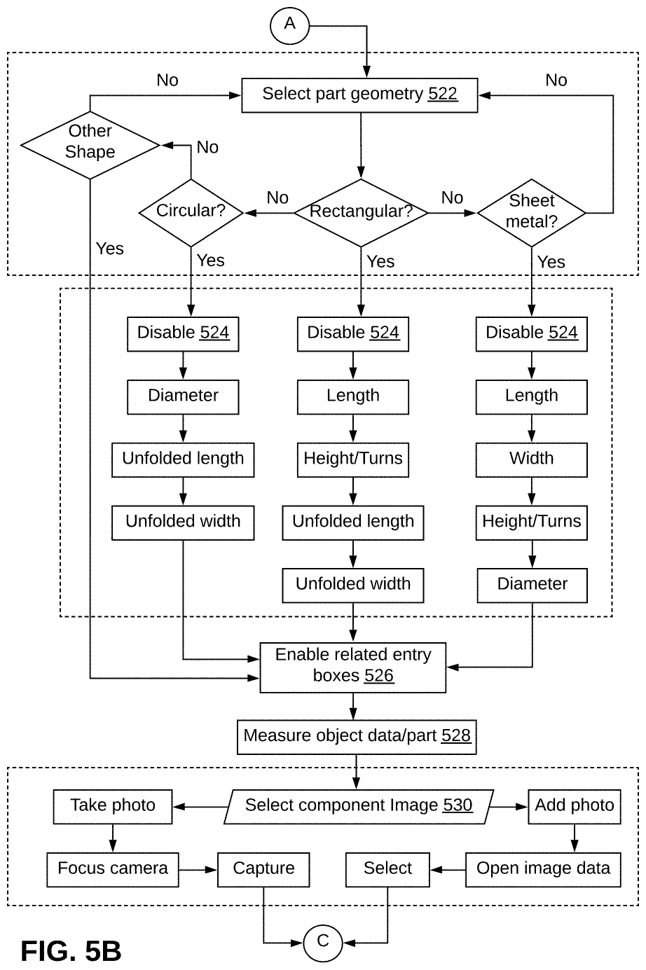

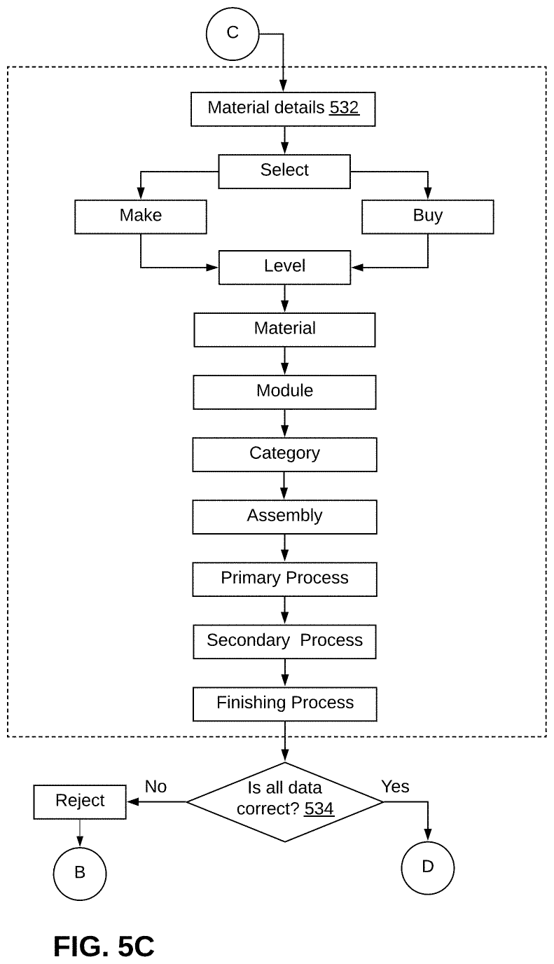

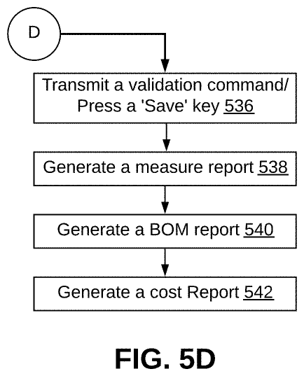

Referring now to FIGS. 5A-5D, an exemplary process 500 of generating BOM for the product is depicted in greater detail via flowcharts, in accordance with some embodiments of the present disclosure. All the steps may be performed by various modules of the BOM generating device 102 and associated instruments/devices. At step 502, a component may be selected. The component may be selected from a plurality of components of a product. In some embodiments, selection of the component may be performed based on a user requirement. Further, at step 504, the information recording instruments 202 may be initialized and connected to the system to capture information associated with the selected component. The information recording instruments may include some measuring instruments such as a digital tape, a digital Vernier scale, a micrometre, a digital height gauge, and a digital weighing scale to record measurement parameters associated the component. The measurement parameters may be a height of the component, a length of the component, a width of the component, a weight of the component, a diameter of the component, and a thickness of the component. In some other embodiments, an imaging device like a web camera may be used as an information recording instrument to capture image of the component. An identification number may be captured with the help connected imaging device or a communicatively connected bar code or QR code scanning device.

At step 506, a transmitter may transmit the recorded information to a receiver via a wired or wireless connectivity like Bluetooth, Wi-Fi, and Radio frequency technology. Thereafter, at step 508, the receiver may receive information associated with the component transmitted by the transmitter. At step 510, the information may be transmitted to a computing device. Examples of the computing device may include, but not limited to, a computer, a laptop, a microcontroller, a tablet, or the like. At step 512, a condition may be checked i.e. whether the system (same as the system 100) is ready to operate or not. In case the system is ready to operate, a next step may be executed, otherwise the previous steps from 504 may be performed again until the condition becomes favourable.

At step 514, upon satisfying the system condition, information of the component may be transmitted to a user interface by the computing device. The user interface may correspond to the GUI. After that, at step 516 information associated with the identification number of the component or a pre-printed sticker of the component captured by the bar code scanning device may be considered. Based on that, at step 518, a data entry page or the plurality of data fields may be displayed. In some embodiments, the data entry page may include the plurality of data. At step 520, a condition that the data entry page is opened or not may be verified. If the data entry page is not opened, then the step 518 may be executed again.

At step 522, a geometry 402c may be selected. It should be noted that shape of the component may be checked to select the part geometry. The part geometry may be selected automatically, based on image of the component, in accordance with some embodiments of the present invention. In some other embodiments, the user may select shape of the component. Some pre-defined shapes like a circular shape, a rectangular shape, a sheet metal may appear on the data entry page for selection. In case, shape of the component does not match with any of the pre-defined shape the process may again execute the step 522. At step 524, a plurality of entry boxes corresponding to measurement parameters may be identified. The plurality of entry boxes may be different for different shapes as shown in FIG. 5b. Thereafter, at step 526, corresponding to the selected shape and based on the identified entry boxes, related entry boxes may be enabled. Afterwards, based on measured information each of the entry boxes may be populated with an appropriate measurement parameter value.

At step 530, a component image may be selected. To select image of the component, two options may be provided. one option, the image of the component may be uploaded directly by a key ‘Add a Photo’. In this option the user needs to select one of a plurality of images stored in the database by pressing the key ‘Add a Photo’. In another option ‘Take photo’, a facility of taking a photo via the connected imaging device like a web camera may be provided. At step 532, material details including product category, product material, level, module, buy, make, assembly, primary process, secondary process, and finishing process may be provided.

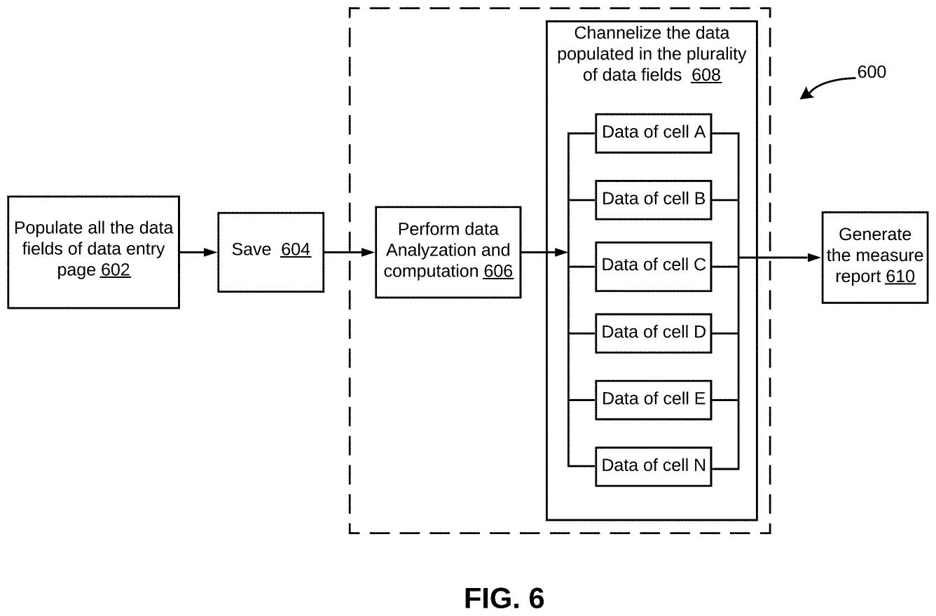

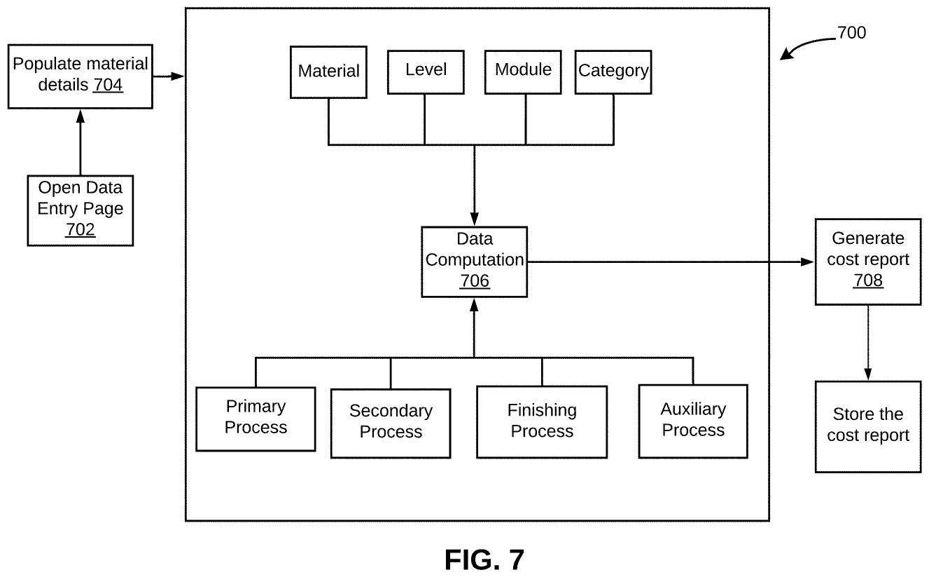

At step 534, when the data fields are populated with data associated with to the component, the data fields may be mapped again to each of the measurement parameters in order to check whether the data fields are populated appropriately with correct information or not. In case, the data fields are populated with incorrect information, all the steps from 512 of the FIG. 5a may be performed again. Otherwise, at step 536, a validation command may be transmitted by pressing the ‘Save ‘key’ provided on the GUI, as shown in FIG. 4. Now, at step. 538, a measure report may be generated. To generate the measure report, the data fields may be evaluated by the measure report generator 208. A process to generate the measure report may be explained in greater detail in conjunction to FIG. 6. At step 540, a BOM report may be generated based on the plurality of records in the BOM database. At step 542, based on a cost estimation performed on the BOM report, a cost report may be generated. A process to generate the cost report may be explained in greater detail in conjunction to FIG. 7.

Referring now to FIG. 6, an exemplary process 600 of generating the measure report is depicted via a flowchart, in accordance with some embodiments of the present disclosure. At step 602, the plurality of data fields in the GUI may be populated, as explained in greater detail in conjunction to FIG. 4-5d. At step 604, after mapping the plurality of data fields with each measurement parameter, a save key may be used by the user to transmit a validation command for storing the plurality of data fields.

Thereafter, at step 606, a data analysis and data computation may be performed on the plurality of data fields. It should be noted that the data analysing and computation module 208a may perform the step 606. At step 608, the populated plurality of data fields may be channelized to different cells in a pre-defined order. It should be noted that channelization of the plurality of data fields may be performed based on analyzation and computation performed by the data analysing and computation module 208a. In FIG. 6, it is clearly represented that the data populated in the plurality of data fields may be channelized in cells ‘A’, ‘B’, ‘C’, ‘D’, ‘E’, and ‘N’. At step 610, the measure report may be generated based on evaluation of the data associate with the plurality of data field.

Referring now to FIG. 7, an exemplary process 700 of generating the cost report is depicted via a flowchart, in accordance with some embodiments of the present disclosure. At step 702, a data entry page in the GUI may be opened. A process to open the data entry page so as to populate the plurality data fields has been already explained in conjunction to FIGS. 5A-5D. Then, at step 704, some of the plurality of data fields associated with material details 404 of second section as shown in FIG. 4 may be populated. The material details may include product category, module type, level, product material. Also, the material details 404 may include a primary process, a secondary process, a finishing process, and other auxiliary processes. Whole data corresponding to the data fields of material details may be integrated to perform the cost estimation. At step 706, a data computation on the material details 404 may be performed for the cost estimation. It should be noted that a database (e.g., manufacturing processes costing data base) may store cost details of various raw materials that may be used for manufacturing one or more components of the product. Further, based on a selection of a component, the specifications of raw material may become known. For example, if the component is made of mild still material using machining and weighs 100 grams, the data computation may be performed to estimate an appropriate cost based on the specifications. At step 708, based on cost estimation, the cost report for the product may be generated. Finally, at step 710, the generated cost report may be stored in a data store (analogues to the BOM database).

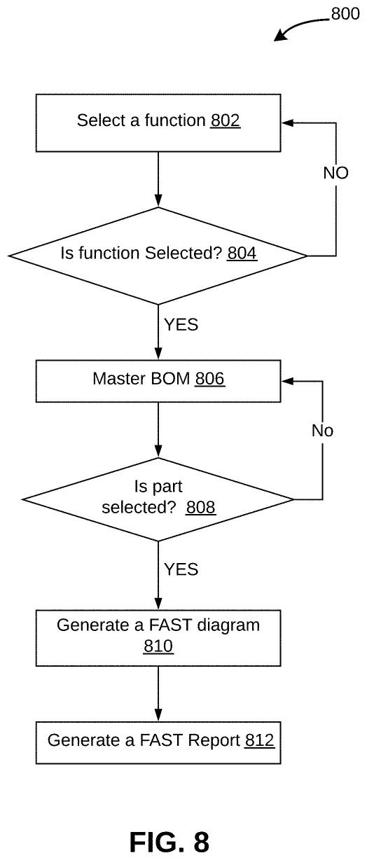

Referring now to FIG. 8, an exemplary process 800 of generating the FAST report is depicted via a flowchart, in accordance with some embodiments of the present disclosure. At step 802, a function for generating the FAST report of the product may be selected. In some embodiments function and corresponding sub functions may be selected based on construction of the product or component. At step 804, whether the function corresponding the product information is selected not, may be verified. In case the function is not selected, the previous step needs to be performed again. Otherwise, a next step may be executed. At step 806, a master BOM may be accessed. The master BOM may include three columns of component or the part information for example, an ‘Identification Number’, a ‘Part Name’, and a ‘Part Cost’.

It should be noted that a functional analysis page may allow selection of one or plurality number of components for a function and sub function. Thereafter, at step 808, a condition ‘if the part is selected or not’ may be checked. In case the part is still not selected, the process 800 may again execute the previous step. In some embodiments, the selected functions and sub functions may be enabled to pull the data from pre-defined database Additionally, post selection of one or plurality of components, corresponding data may be copied to a specific location, and the functions and respective component's cost information may be mapped. At step 810, a FAST diagram may be generated, after the condition of step 808 is verified. At step 812, a FAST report may be generated based on the FAST diagram.

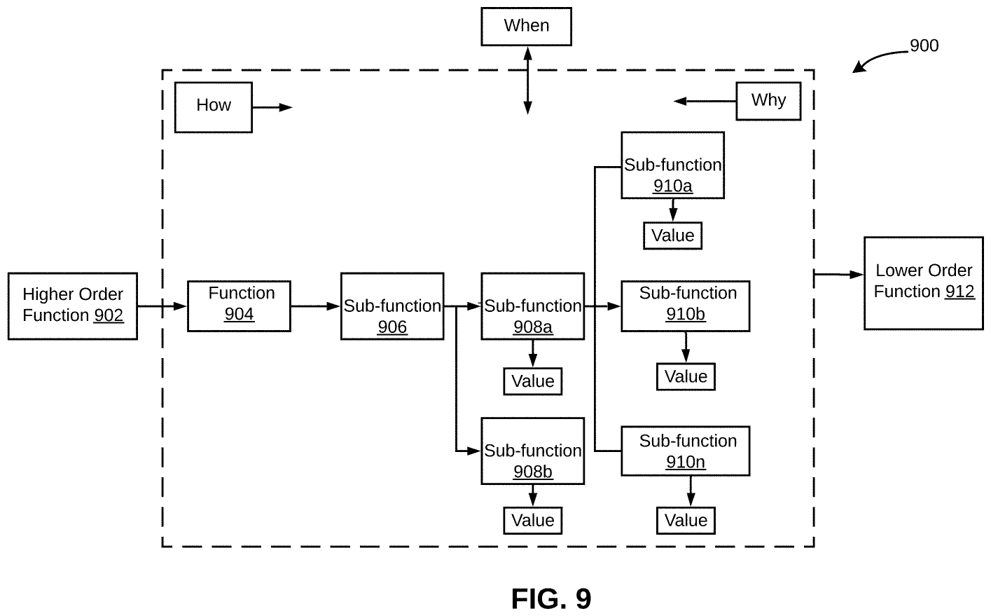

Referring now to FIG. 9, an exemplary process 900 for generating FAST diagram using functional values' information is depicted via a flowchart, in accordance with some embodiments of the present disclosure. In some embodiments, the process includes generation of a lower order function 912 from a higher order function 902. Some pre-defined standard functions and sub-functions (i.e., set of pre-defined functions and sub-functions) may be selected for performing a functional value analysis. It should be noted that the set of pre-defined functions and sub-functions may be used in a ‘verb+noun’ format and may be customized for a specific product. In some embodiments, the set of pre-defined functions and sub-functions may be mapped to one or more specific components of the specific product. The customization to the pre-defined functions and sub functions may be performed based on the construction of the product. Initially, a function 904 associated with the product or the component may be selected. Thereafter, a corresponding sub-function 906 may be selected from a plurality of sub-functions associated with the selected function 904.

Further, two sub-functions 908a and 908b may be selected and corresponding values may be determined. Now, for each of the sub-functions 908a and 908b, one or more sub-functions may be selected. Expansion of the sub-function 908a is clearly illustrated in FIG. 9. For example, the selection may include the sub-functions 910a, 910b up to 910n. And corresponding values may be determined. Hence, based on the functional value analyses a FAST diagram may be generated. In some embodiments, customization to functions and sub-functions may be also performed based on construction of the product.

Thus, the present disclosure may help in eliminating manual requirement of generating BOM for products by introducing automation in the field. As, the disclosure introduce automation in dimension generation, weight gathering as well as positioning images at right location, productivity may be enhanced. by fifty percent, when compared with conventional procedures. Additionally, the disclosure delivers some advantages like reduction in manual errors, quality improvement, enhanced accuracy and less time consumption. The disclosed system may be an offline system and may be updated regularly by bringing it to connectivity. In future, it may be easy to track the images of the part only through the part names and smart labels. Also, the disclosure involves FAST diagram generation automatically by selecting functions and associated components, thereby reduces the operational time and deliverable quality. Thus, in short, the disclosure provides a robust method and system with improved productivity and quality.

It will be appreciated that, for clarity purposes, the above description has described embodiments of the invention with reference to different functional units and processors. However, it will be apparent that any suitable distribution of functionality between different functional units, processors or domains may be used without detracting from the invention. For example, functionality illustrated to be performed by separate processors or controllers may be performed by the same processor or controller. Hence, references to specific functional units are only to be seen as references to suitable means for providing the described functionality, rather than indicative of a strict logical or physical structure or organization.

Although the present invention has been described in connection with some embodiments, it is not intended to be limited to the specific form set forth herein. Rather, the scope of the present invention is limited only by the claims. Additionally, although a feature may appear to be described in connection with particular embodiments, one skilled in the art would recognize that various features of the described embodiments may be combined in accordance with the invention.

Furthermore, although individually listed, a plurality of means, elements or process steps may be implemented by, for example, a single unit or processor. Additionally, although individual features may be included in different claims, these may possibly be advantageously combined, and the inclusion in different claims does not imply that a combination of features is not feasible and/or advantageous. Also, the inclusion of a feature in one category of claims does not imply a limitation to this category, but rather the feature may be equally applicable to other claim categories, as appropriate.

What is claimed is:

1. A method of generating a Bill of Materials (BOM) for a product, the method comprising:
acquiring, by a BOM generating device, information associated with a component of the product using a plurality of communicatively connected information recording instruments, wherein the information comprises a set of measurement parameters recorded using a set of communicatively connected measuring instruments;
automatically populating, by the BOM generating device, a set of data fields in a graphic user interface (GUI) based on the acquired information and a shape of the component, wherein the shape of the component is selected by a user from a list of pre-defined shapes or is identified based on an image of the component, and wherein the set of data fields is among a plurality of data fields in the GUI;
receiving, by the BOM generating device, a validation command from the user via the GUI;
upon receiving the validation command, storing, by the BOM generating device, the plurality of data fields as one of a plurality of records in a BOM database for the product, wherein each of the plurality of records in the BOM database corresponds to each of a plurality of components in the product.

2. The method of claim 1, wherein the set of measurement parameters comprises at least one of a height of the component, a length of the component, a width of the component, a weight of the component, a diameter of the component, and a thickness of the component; and wherein the set of communicatively connected measuring instruments comprises a digital tape, a digital Vernier scale, a digital micrometre, a digital height gauge, and a digital weighing scale.

3. The method of claim 1, wherein the information further comprises, at least one of:
the image of the component captured using a communicatively connected imaging device, and wherein the communicatively connected imaging device comprises a web camera; and
an identification number of the component captured using one of the communicatively connected imaging device and a communicatively connected bar code scanning device.

4. The method of claim 1, further comprising identifying, by the BOM generating device, the shape of the component based on the image of the component using image processing algorithm, wherein the shape comprises at least one of a rectangular shape, a circular shape, and a sheet shape.

5. The method of claim 1, wherein automatically populating the set of data fields comprises mapping each of the set of measurement parameters with each of the set of data fields based on the shape of the component.

6. The method of claim 1, further comprising receiving, by the BOM generating device, additional information associated with the component from the user via the GUI, wherein the additional information corresponds to remaining of the plurality of data fields in the GUI.

7. The method of claim 1, further comprising generating, by the BOM generating device, at least one of:
a measure report based on an evaluation of the plurality of data fields prior to storing the plurality of data fields as one of the plurality of records in the BOM database,
a BOM report based on the plurality of records in the BOM database,
a cost report by performing a cost estimation based on the BOM report, and
a FAST report by performing a functional analysis based on at least one of the BOM report and the cost report, wherein the functional analysis comprises a set of pre-defined functions and sub-functions customized for the product and mapped to a plurality of components of the product.

8. A system for generating a Bill of Materials (BOM) for a product, the system comprising:
a processor; and
a memory communicatively coupled to the processor, wherein the memory stores processor-executable instructions, which, on execution, causes the processor to:
acquire information associated with a component of the product using a plurality of communicatively connected information recording instruments, wherein the information comprises a set of measurement parameters recorded using a set of communicatively connected measuring instruments;
automatically populate a set of data fields in a graphic user interface (GUI) based on the acquired information and a shape of the component, wherein the shape of the component is selected by a user from a list of pre-defined shapes or is identified based on an image of the component, and wherein the set of data fields is among a plurality of data fields in the GUI;
receive a validation command from the user via the GUI;
upon receiving the validation command, store the plurality of data fields as one of a plurality of records in a BOM database for the product, wherein each of the plurality of records in the BOM database corresponds to each of a plurality of components in the product.

9. The system of claim 8, further comprising the plurality of communicatively connected information recording instruments comprising at least one of:
the set of communicatively connected measuring instruments for recording the set of measurement parameters, wherein the set of measurement parameters comprises at least one of a height of the component, a length of the component, a width of the component, a weight of the component, a diameter of the component, and a thickness of the component; and wherein the set of communicatively connected measuring instruments comprises a digital tape, a digital Vernier scale, a micrometre, a digital height gauge, and a digital weighing scale; and
at least one of a communicatively connected imaging device and a communicatively connected bar code scanning device for capturing at least one of the image of the component and an identification number of the component as a part of the information, wherein the communicatively connected imaging device comprises a web camera.

10. The system of claim 8, wherein the processor-executable instructions further cause the processor to identify the shape of the component based on the image of the component using image processing algorithm, wherein the shape comprises at least one of a rectangular shape, a circular shape, and a sheet shape.

11. The system of claim 8, wherein automatically populating the set of data fields comprises mapping each of the set of measurement parameters with each of the set of data fields based on the shape of the component.

12. The system of claim 8, wherein the processor-executable instructions further cause the processor to receive additional information associated with the component from the user via the GUI, wherein the additional information corresponds to remaining of the plurality of data fields in the GUI.

13. The system of claim 8, wherein the processor-executable instructions further cause the processor to generate at least one of:
a measure report based on an evaluation of the plurality of data fields prior to storing the plurality of data fields as one of the plurality of records in the BOM database,
a BOM report based on the plurality of records in the BOM database,
a cost report by performing a cost estimation based on the BOM report, and
a FAST report by performing a functional analysis based on at least one of the BOM report and the cost report, wherein the functional analysis comprises a set of pre-defined functions and sub-functions customized for the product and mapped to a plurality of components of the product.

14. A non-transitory computer-readable medium storing computer-executable instructions for generating a Bill of Materials (BOM) for a product, the computer-executable instructions configured for:
acquiring information associated with a component of the product using a plurality of communicatively connected information recording instruments, wherein the information comprises a set of measurement parameters recorded using a set of communicatively connected measuring instruments;
automatically populating a set of data fields in a graphic user interface (GUI) based on the acquired information and a shape of the component, wherein the shape of the component is selected by a user from a list of pre-defined shapes or is identified based on an image of the component, and wherein the set of data fields is among a plurality of data fields in the GUI;
receiving a validation command from the user via the GUI;
upon receiving the validation command, storing the plurality of data fields as one of a plurality of records in a BOM database for the product, wherein each of the plurality of records in the BOM database corresponds to each of a plurality of components in the product.

15. The non-transitory computer-readable medium of claim 14, wherein automatically populating the set of data fields comprises mapping each of the set of measurement parameters with each of the set of data fields based on the shape of the component.

16. The non-transitory computer-readable medium of claim 14, wherein the computer-executable instructions are further configured for generating at least one of:
a measure report based on an evaluation of the plurality of data fields prior to storing the plurality of data fields as one of the plurality of records in the BOM database,
a BOM report based on the plurality of records in the BOM database,
a cost report by performing a cost estimation based on the BOM report, and
a FAST report by performing a functional analysis based on at least one of the BOM report and the cost report, wherein the functional analysis comprises a set of pre-defined functions and sub-functions customized for the product and mapped to a plurality of components of the product.
